(19) United States
(12) Patent Application Publication
(10) Pub. No.: US 2016/0342319 A1
(43) Pub. Date: Nov. 24, 2016

(54) METHOD AND DEVICE FOR PREVIEWING AND DISPLAYING MULTIMEDIA STREAMING DATA

(71) Applicant: LEMOBILE INFORMATION TECHNOLOGY (BEIJING) CO., LTD., Beijing (CN)

(72) Inventors: Xiaobin WANG, Beijing (CN); Bo LI, Beijing (CN); Shengkai WANG, Beijing (CN); Xizhe XIAO, Beijing (CN); Shixing LI, Beijing (CN); Liang LI, Beijing (CN)

(21) Appl. No.: 15/158,754

(22) Filed: May 19, 2016

(30) Foreign Application Priority Data
May 19, 2015 (CN) 201510256155.6

(51) Int. Cl. G06F 3/0484; G06F 3/0482; G06F 3/0481; H04L 29/06; H04L 29/08

(52) U.S. Cl. CPC G06F 3/04847; H04L 65/601; H04L 67/02; G06F 3/04817; G06F 3/0482

(57) ABSTRACT

The embodiments of the present invention provide a method and a device for previewing and displaying multimedia streaming data, wherein the method includes: when a terminal displays a designated interface, determining a thumbnail display area corresponding to at least one previewing and playing area preset in the designated interface, acquiring multimedia streaming data corresponding to the previewing and playing area, loading a floating layer playing control in the previewing and playing area, and previewing and playing the multimedia streaming data. Through the method, the previewing and playing area is preset in the designated interface including the thumbnail display area; when the designated interface is displayed in the terminal, the thumbnail display area corresponding to the previewing and playing area is determined, so as to play the multimedia streaming data in the thumbnail display area in the floating layer playing control loaded in the previewing and playing area, and the floating layer playing control can preview and play the multimedia streaming data, so as to effectively and exactly reflect the contents in the multimedia streaming data.

### CROSS REFERENCE TO RELATED APPLICATION

This application claims priority under 35 U.S.C. §119(a) to Patent Application No. 201510256155.6, filed in China on May 19, 2015, the entire contents of which is hereby incorporated by reference.

### TECHNICAL FIELD

The embodiments of the present invention relate to the field of multimedia technologies, and particularly, to a method and a device for previewing and displaying multimedia streaming data.

### BACKGROUND

With the development of information technology, users may conveniently acquire and browse various multimedia contents (such as video, audio, Flash animation, or the like) through a smart terminal (such as a smartphone, a tablet, a computer, or the like), so as to satisfy their demands on such aspects as life, working, entertainment, etc.

At present, there are a variety of multimedia contents. In order to enable the users to intuitively select the multimedia contents that they themselves want to look up, multimedia providers (for example: a website) will preview and display various multimedia contents in relevant pages (for example: a webpage, an application interface, or the like) usually. Particularly for videos, the multimedia providers will take a certain frame of image in the video contents as a thumbnail of the video contents to preview and display in a relevant interface. This manner is widely applied.

However, the foregoing previewing and displaying manner can only be direct at a scenario with constant video contents usually, while for a live program or inconstant video contents which are played in turn, it is difficult to reflect the video contents only through the thumbnail of the frame of image. Similarly, the foregoing defects also present in the multimedia contents in other forms, such as audios.

### SUMMARY

The embodiments of the present invention provide a method and a device for previewing and displaying multimedia streaming data, for solving the defect of low accuracy in the prior art that previews and displays the multimedia contents using a thumbnail manner

The embodiment of the present invention provides a method for previewing and displaying multimedia streaming data, including:

determining, by a terminal, a previewing and playing area corresponding to a thumbnail display area;

acquiring multimedia streaming data corresponding to the previewing and playing area;

loading a floating layer playing control in the previewing and playing area; and

previewing and playing the multimedia streaming data through the floating layer playing control.

The embodiment of the present invention provides a device for previewing and displaying multimedia streaming data, including:

a determination module configured to determine a previewing and playing area corresponding to a thumbnail display area;

an acquisition module configured to acquire multimedia streaming data corresponding to the previewing and playing area;

a loading module configured to load a floating layer playing control in the previewing and playing area; and

a previewing and playing module configured to preview and play the multimedia streaming data through the floating layer playing control.

According to the method and device for previewing and displaying multimedia streaming data provided by the present invention, the previewing and playing area is preset in the designated interface including the thumbnail display area; when the designated interface is showed in the terminal, the thumbnail display area corresponding to the previewing and playing area is determined, so as to play the multimedia streaming data in the thumbnail display area in the floating layer playing control loaded in the previewing and playing area; in this way, compared with the prior art which previews and displays using a thumbnail manner, the floating layer playing control in the embodiment of the present invention can preview and play the multimedia streaming data, and can effectively and exactly reflect the multimedia contents in the multimedia streaming data.

### BRIEF DESCRIPTION OF THE DRAWINGS

In order to explain the technical solutions in the embodiments of the invention or in the prior art more clearly, the drawings used in the descriptions of the embodiments or the prior art will be simply introduced hereinafter. It is apparent that the drawings described hereinafter are merely some embodiments of the invention, and those skilled in the art may also obtain other drawings according to these drawings without going through creative work.

FIG. 1 is a flow chart of a method embodiment for previewing and displaying multimedia streaming data of the present invention;

FIG. 2 is a schematic diagram of a certain video menu interface in the embodiment of the present invention;

FIG. 3 is a schematic diagram of a previewing and playing area in a certain video menu interface in the embodiment of the present invention;

FIG. 4 is a schematic diagram for loading a floating layer playing control in a previewing and playing area to preview and play in the embodiment of the present invention;

FIG. 5a is a schematic diagram of another video menu interface in the embodiment of the present invention;

FIG. 5b is a schematic diagram of another video menu interface after sliding in the embodiment of the present invention;

FIG. 5c is a schematic diagram of dragging direct at the floating layer playing control in the embodiment of the present invention;

FIG. 5d is a schematic diagram for a terminal to re-enter the video menu interface after dragging the floating layer playing control in the embodiment of the present invention; and

FIG. 6 is a structure diagram of a apparatus embodiment for previewing and displaying multimedia streaming data of the present invention.

### DETAILED DESCRIPTION

To make the objects, technical solutions and advantages of the embodiments of the present invention more clearly, the technical solutions in the embodiments of the present invention will be clearly and completely described hereinafter with reference to the embodiments and corresponding drawings of the present invention. Apparently, the embodiments described are partial embodiments of the present invention, rather than all embodiments. Other embodiments derived by those having ordinary skills in the art on the basis of the embodiments of the invention without going through creative efforts shall all fall within the protection scope of the present invention.

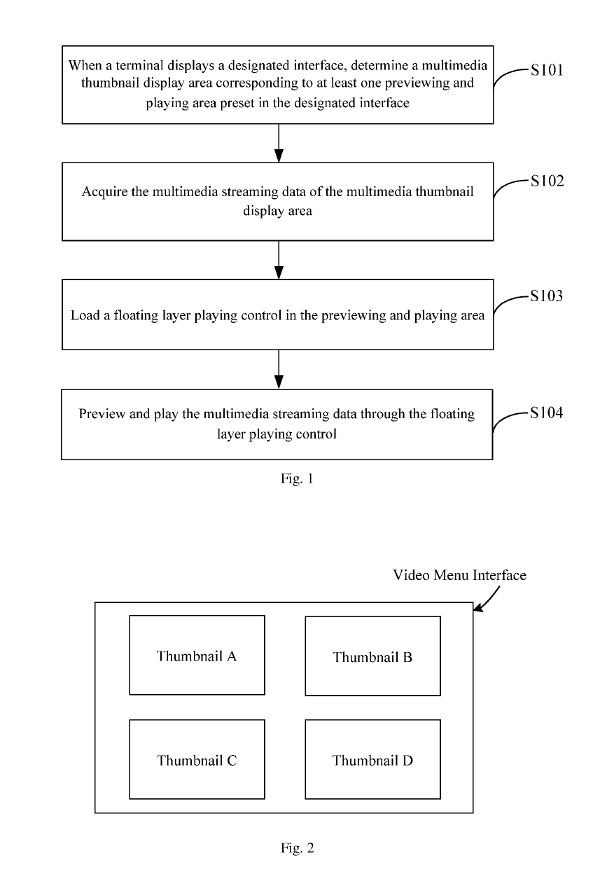

FIG. 1 is a method for previewing and displaying multimedia streaming data provided by the embodiment of the present invention. The method specifically includes the following steps.

In S101, a previewing and playing area corresponding to a thumbnail display area is determined by a terminal.

In the embodiment of the present invention, the terminal includes, but is not limited to such mobile terminals as a smartphone, a tablet or the like, or a computer terminal.

In a practical application scenario, the thumbnail display area and the previewing and playing area are both displayed in a designated interface. It should be illustrated herein that the designated interface includes at least one of a webpage and an application interface containing the thumbnail display area, for example: the homepage of a video website, the main interface of a video application, or the like. In the embodiment of the present invention, the thumbnail display area is configured to display the thumbnail and icon of such multimedia streaming data as a video, an audio, an animation, or the like.

In the prior art, multimedia contents are usually previewed using a thumbnail manner, which cannot effectively reflect the concrete contents of such multimedia in the forms of live telecast, carousel or broadcast, or the like. Therefore, the relevant previewing and playing area is set in the embodiment of the present invention, so as to preview and play videos in the previewing and playing area subsequently.

It should be illustrated that the display position and the display number of the previewing and playing area in the designated interface can be preset by the users. As a preferred manner, in order to preview and play the multimedia streaming data in the thumbnail display area, the display position of the previewing and playing area is usually overlapped with the display position of the thumbnail display area, which namely represents that the multimedia contents in the thumbnail display area will be previewed and played; therefore, when the terminal shows the designated interface, the thumbnail display area corresponding to the previewing and playing area will be determined firstly for subsequent previewing and playing.

In S102, multimedia streaming data corresponding to the previewing and playing area is acquired.

Different thumbnail display areas correspond to different multimedia streaming data, and the users may directly conduct relevant operations on the thumbnail display area (for example, a click operation), so that the designated interface will jump to a relevant playing interface.

That is, if it is expected to preview and play the multimedia streaming data in the relevant thumbnail display area, then it is needed to determine the video streaming data in the video content area corresponding to the previewing and playing area.

The multimedia streaming data in the embodiment of the present invention is concretely transmitted to the terminal by a relevant server (for example: a video server, an audio server, a radio station server, or the like), which does not limit the present invention herein.

In S103, a floating layer playing control is loaded in the previewing and playing area.

The floating layer playing control may be a suspension type playing window, suspending on the relevant thumbnail display area.

In S104, the multimedia streaming data is previewed and played through the floating layer playing control.

After the multimedia streaming data corresponding to the thumbnail display area is determined, the multimedia streaming data can be previewed and played. In the embodiment of the present invention, the multimedia streaming data is previewed and played through the floating layer playing control loaded in the previewing and playing area.

Certainly, the floating layer playing control in the embodiment of the present invention may employ different previewing and playing manners for different multimedia streaming data, for example: for audio streaming data, the floating layer playing control can directly preview and play the audio streaming data, and such text information like the name and contents of the audio can also be displayed on the floating layer playing control while playing the audio streaming data. For another example: for the video streaming data, the floating layer playing control employs a suspension playing window manner to play the video streaming data. The previewing and playing manner of the floating layer playing control does not limit the present invention.

According to the foregoing steps, the previewing and playing area is preset in the interface including the thumbnail display area; when the interface is displayed in the terminal, the thumbnail display area corresponding to the previewing and playing area will be determined, so as to play the multimedia streaming data in the thumbnail display area in the floating layer playing control loaded in the previewing and playing area; in this way, compared with the manner employed in the prior art which previews and displays using a thumbnail, the floating layer playing control in the embodiment of the present invention can preview and play the multimedia streaming data, and can effectively and exactly reflect the multimedia contents in the multimedia streaming data.

With regard to the foregoing method for displaying information, it is described in details hereinafter in a scenario that the multimedia streaming data includes video streaming data and the thumbnail display area includes a video thumbnail.

In the example, the video streaming data can be video streaming data in the form of live telecast or carousel.

During practical application, in view of that the user in an interface containing a plurality of video thumbnails (i.e., thumbnail display areas) may possibly want to preview the video streaming data corresponding to the plurality of thumbnails, the user can respectively set a corresponding previewing and playing area for the plurality of video thumbnails in such a case, so as to perform multipass previewing. Then, when performing multipass previewing, the concrete process thereof is as follows: respectively determining a previewing and playing area corresponding to each video thumbnail, respectively acquiring each video streaming data corresponding to each video thumbnail, respectively loading each video streaming data to a floating layer playing control in the previewing and playing area corresponding to the video thumbnail for previewing and playing.

For example, it is provided that a certain video menu interface, as shown in FIG. 2, shows four thumbnails, i.e., thumbnails A˜D, and the four thumbnails are respectively corresponding to different four types of video programs (i.e., videos a˜d), the user, after performing a click operation direct at any thumbnail therein, will enter the corresponding playing interface for playing the video program.

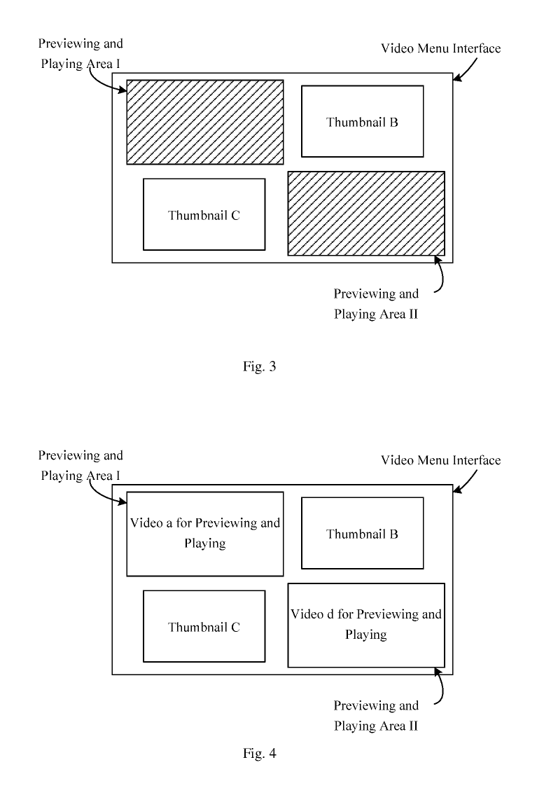

It is provided that in the example, the video menu interface, as shown in FIG. 3, is preset with two previewing and playing areas, i.e., a previewing and playing area I and a previewing and playing area II. Wherein, the previewing and playing area I is set in a display position where the thumbnail A is located, and the previewing and playing area II is set in a display position where the thumbnail B is located.

When the user uses a terminal apparatus to enter the video menu interface, the terminal apparatus will determine that the previewing and playing areas I and II respectively correspond to the thumbnails A and D. Therefore, the terminal apparatus will acquire the video streaming data of the videos a and d corresponding to the thumbnails A and D. At this moment, the terminal apparatus loads a suspension type floating layer playing control in the previewing and playing areas I and II, and respectively previews and plays the two video streaming data of the videos a and d through two floating layer playing controls. That is, as shown in FIG. 4, the video a is previewed and played in the previewing and playing area I, and the video d is previewed and played in the previewing and playing area II.

It can be seen from the above example that through the method of the embodiment of the present invention, a plurality of previewing and playing areas can be set in the video menu interface, so as to implement multipass previewing and playing direct at a plurality of video programs, which not only improves the defect of the prior art that employing a static thumbnail to preview may possibly cause that the previewing cannot exactly and sufficiently reflect the video contents, but also effectively improves the previewing convenience on the video contents.

It should be illustrated herein that, in the foregoing multipass previewing and playing scenario, each video streaming data includes relevant audio data. That is, when performing multipass previewing and playing, the contents played by each floating layer playing control will give out relevant audios; then, a riot of sound will appear. Therefore, as a preferred manner in the embodiment of the present invention, in the current interface, when a plurality of the thumbnail display areas are present, and when the number of the previewing and playing area in the current interface is more than one, the multimedia streaming data is previewed and played through the floating layer playing control, which specifically includes: selecting the audio data and video data in any video streaming data, previewing and playing the audio data and video data in the corresponding floating layer playing control, and shielding the audio data in the video streaming data previewed and played by other floating layer playing controls.

To continue the above example, the videos a and d are respectively previewed and played in the previewing and playing area I and the previewing and playing area II, and the audio data in the video a and in the video d are played at the same time apparently; in this way, a riot of sound will appear. At this moment, it is provided that the terminal apparatus selects the video a and also plays the audio data in the video streaming data of the video a, but shields the audio data of the video d.

Through such a manner, in a multipass previewing and playing scenario, only the sound of one video is played normally, while the other videos will be played in silence. In this way, a riot of sound can be avoided while performing multipass previewing and playing.

Moreover, during practical application, in view of that the user will conduct relevant operations in a video menu interface, for example, a slide operation direct at the video menu interface, or a click operation direct at the floating layer playing control, or the like, these operations conducted by the user will produce relevant influences on the floating layer playing control. Therefore, the terminal will monitor the relevant operations conducted by the user in the video menu interface.

To be specific, in one case, the method for previewing and displaying multimedia streaming data in the embodiment of the present invention further includes: when a click operation direct at the floating layer playing control is monitored, stopping previewing and playing through the floating layer playing control, and jumping to a play page, so as to play the video streaming data previewed and played by the floating layer playing control.

In the floating layer playing control, previewing and playing are performed direct at the video streaming data of the corresponding video thumbnail; in this way, the user can intuitively browse the video contents corresponding to different video thumbnails. The user will select the video contents expected to view thereof, and just will click the relevant floating layer playing control. In this way, it represents that the user wants to view the video contents played by the floating layer playing control; therefore, the video menu interface will jump to the play page to play the video contents.

In the foregoing case, when the video contents played in the play page are completed, or the user conducts a returning operation in the play page, then the current interface will return back to the video menu interface again; at this moment, it is still desirable to continuously preview and play the video thumbnail in the video menu interface. Therefore, in the embodiment of the present invention, the method further includes: when monitoring that it is jumped from the play page to the previewing interface, re-acquiring the multimedia streaming data corresponding to the previewing and playing area, and loading the floating layer playing control in the previewing and playing area again, so as to preview and play the multimedia streaming data.

In the embodiment of the present invention, the previewing interface is just an interface that includes the thumbnail display area, i.e., the video menu interface in the foregoing example. The manner of jumping from the play page to the previewing interface may include: monitoring an instruction for closing the play page by the terminal.

Certainly, loading the floating layer playing control in the previewing and playing area again for previewing and playing is not limited to the manner of returning from the play page to the previewing interface. In an actual applying scenario, the floating layer playing control will be loaded in the previewing and playing area again for previewing and playing as long as such operations like reopening and refreshing are conducted on the previewing interface. The present application is not limited herein.

In another case, the method for previewing and displaying multimedia streaming data in the embodiment of the present invention further includes: when a slide operation direct at the current interface is monitored, controlling the thumbnail display area in the current interface to slide, and controlling the floating layer playing control not to slide.

A plurality of video thumbnails are usually included in the video menu interface; because it is not possible to completely show all the video thumbnails in the current show window due to the size limitation of the current show window; in this way, the user will conduct a slide operation direct at the video menu interface, so as to browse other video thumbnails that are not showed. As a manner of the foregoing case, if the current video menu interface includes a plurality of previewing and playing areas, it is provided that each previewing and playing area slides with the slide operation of the user, then the display positions of different previewing and playing areas may be possibly overlapped, thus causing disordered showing. Therefore, in the embodiment of the present invention, when the video menu interface includes a plurality of previewing and playing areas, the terminal will only control the thumbnail display area to slide when receiving the slide operation of the user, and control the floating layer playing control not to slide at the same time. That is, the floating layer playing control and the thumbnail display area will not slide synchronously.

Because the number of the previewing and playing area can be set by the user, and the user may possibly set one previewing and playing area only (i.e., there is only one floating layer playing control), at this moment, as another manner of the foregoing case, the display position of the video thumbnail will change with the slide operation of the user; moreover, because the floating layer playing control is showed on the video thumbnail, then the display position of the floating layer playing control will also change with the slide operation of the user.

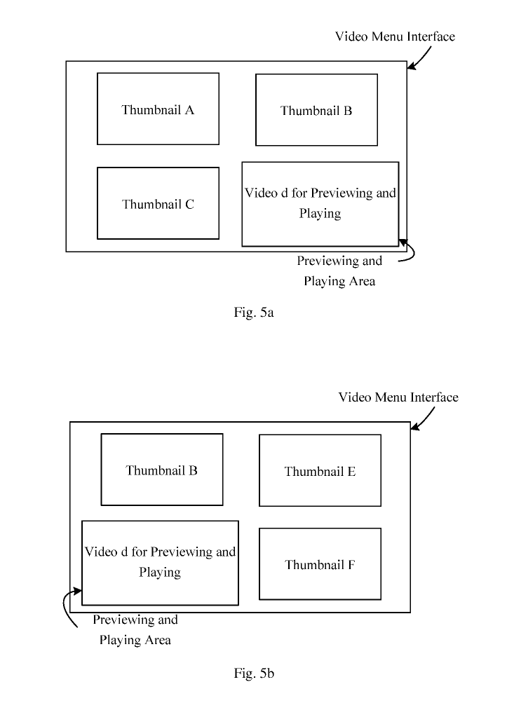

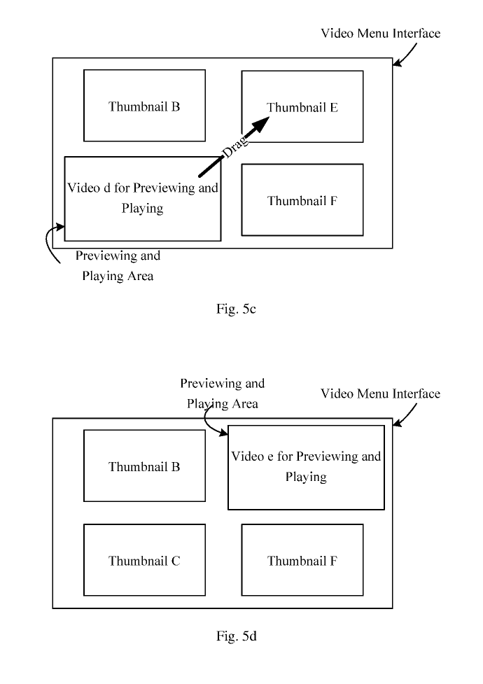

For example, as shown in FIG. 5a, the video menu interface shows four video thumbnails (wherein, the thumbnail D is shielded by the previewing and playing area, and is not shown in FIG. 5a), the previewing and playing area is set in the display position of the thumbnail D, and the floating layer playing control loaded in the previewing and playing area is just previewing and playing the video d.

At this moment, the user conducts a slide operation to the left in the video menu interface (i.e., all the contents showed in the video menu interface are slided to the left), then the floating layer playing control in FIG. 5a will also slide with the slide operation of the user, wherein the position after sliding is as shown in FIG. 5b. During the process that the floating layer playing control slides to the display position in FIG. 5b, the floating layer playing control will continuously preview and play.

As so far, according to the method for previewing and displaying multimedia streaming data in the embodiment of the present invention in the foregoing scenario, multipass previewing and displaying can be conducted; moreover, during the process of previewing and displaying, relevant response change may be conducted according to the relevant operation of the user, which will not affect to preview and display the video contents.

In the embodiment of the present invention, there is also provided an operation scenario direct at the floating layer playing control. That is, the method further includes: when a dragging operation direct at the floating layer playing control is monitored, recording a display position of the previewing and playing area corresponding to the dragged floating layer playing control, and when the terminal shows the previewing interface again, determining a thumbnail display area corresponding to the dragged previewing and playing area, acquiring the multimedia streaming data corresponding to the previewing and playing area, and reloading the floating layer playing control in the previewing and playing area, so as to preview and play the multimedia streaming data.

To continue the example as shown in FIG. 5b now, it is provided that the user drags direct at the floating layer playing control in the video menu interface of FIG. 5b, and drags the floating layer playing control to the position of a thumbnail E, which is namely as shown in FIG. 5c. At this moment, the terminal will record the new display position of the floating layer playing control, and store the relevant display position information (the information may either be stored in the terminal locally, or synchronously stored into the server, which will not be concretely defined herein).

Then, if the terminal loads the video menu interface again (such as: refreshing or returning, or the like), then the terminal, as shown in FIG. 5d, will determine the previewing and playing area according to the new display position (that is, determining the position of the thumbnail E as the previewing and playing area) first, and acquire the video streaming data corresponding to the thumbnail E, and reload the floating layer playing control in the previewing and playing area, so as to preview and play the video streaming data corresponding to the thumbnail E.

The foregoing scenario is only direct at the videos. During practical application, the manner for previewing and displaying the multimedia streaming data in the embodiment of the present invention is also applied to preview and display audios and flash animations, and the foregoing scenario does not limit the present invention.

At least one of a webpage and an application interface containing a live telecast or carousel video display area is included. Wherein, the live telecast or carousel video display area in the designated interface is an operatable video area showed by means of a thumbnail.

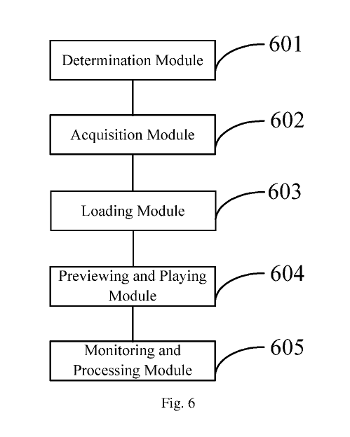

The above is the method for previewing and displaying multimedia streaming data provided by the embodiments of the present invention. Based on the same thought, the embodiments of the present invention also provide a device for previewing and displaying multimedia streaming data, which is as shown in FIG. 6. The device includes:

a determination module 601, configured to, when a terminal displays a designated interface, determine a thumbnail display area corresponding to at least one previewing and playing area preset in the designated interface;

an acquisition module 602, configured to acquire the multimedia streaming data of the thumbnail display area;

a loading module 603, configured to load a floating layer playing control in the previewing and playing area; and

a previewing and playing module 604, configured to preview and play the multimedia streaming data through the floating layer playing control.

In the embodiment of the present invention, the multimedia streaming data includes video streaming data, wherein the video streaming data includes video data and audio data. The thumbnail display area includes a video thumbnail.

Moreover, in the current interface, when a plurality of the thumbnail display areas are present, and when the number of the previewing and playing area in the current interface is more than one, the previewing and playing module 604 is specifically configured to select the audio data and video data in any video streaming data, preview and play the audio data and video data in the corresponding floating layer playing control, and shield the audio data in the video streaming data previewed and played by other floating layer playing controls.

In the embodiment of the present invention, the device further includes: a monitoring and processing module 605, configured to, when a click operation direct at the floating layer playing control is monitored, stop previewing and playing through the floating layer playing control, and jump to a play page, so as to play the video streaming data previewed and played by the floating layer playing control.

The monitoring and processing module 605, is further configured to, when monitoring that it is jumped from the play page to a previewing interface, re-acquire the multimedia streaming data corresponding to the previewing and playing area, and load the floating layer playing control in the previewing and playing area again, so as to preview and play the multimedia streaming data.

The monitoring and processing module 605, is further configured to, when a slide operation direct at the current interface is monitored, control the thumbnail display area in the current interface to slide, and control the floating layer playing control not to slide.

The monitoring and processing module 605 is further configured to, when a dragging operation direct at the floating layer playing control is monitored, record a display position of the previewing and playing area corresponding to the dragged floating layer playing control, and when the terminal shows the previewing interface again, determine a thumbnail display area corresponding to the dragged previewing and playing area, acquire the multimedia streaming data corresponding to the previewing and playing area, and reload the floating layer playing control in the previewing and playing area, so as to preview and play the multimedia streaming data.

Related functional modules of the embodiment of the present invention can be implemented through a hardware processor.

The device embodiments described above are only exemplary, wherein the units illustrated as separation components may either be or not physically separated, and the components showed as units may either be or not physical units, i.e., the components may either be located in the same place, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art, may be implemented in the form of a software product. The computer software product may be stored in a computer-readable storage medium such as a ROM/RAM, a diskette, an optical disk or the like, and includes several instructions for instructing a computer apparatus(which may be a personal computer, a server, or a network apparatus so on) to execute the method according to each embodiment or some parts of the embodiments.

It should be finally noted that the above embodiments are only for explaining the technical solutions of the present invention, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions to depart from the spirit and scope of the claims.

1. A method for previewing and displaying multimedia streaming data, comprising:
determining, by a terminal, a previewing and playing area corresponding to a thumbnail display area;
acquiring multimedia streaming data corresponding to the previewing and playing area;
loading a floating layer playing control in the previewing and playing area; and
previewing and playing the multimedia streaming data through the floating layer playing control.

2. The method according to claim 1, wherein the multimedia streaming data comprises video streaming data, wherein the video streaming data comprises video data and audio data; and
the thumbnail display area is configured to display a video thumbnail.

3. The method according to claim 2, wherein in current interface, when a plurality of the thumbnail display areas are present, and when the number of the previewing and playing area in the current interface is more than one, the previewing and playing the multimedia streaming data through the floating layer playing control specifically comprises:
selecting the audio data and the video data in any video streaming data, previewing and playing the audio data and the video data in the corresponding floating layer playing control, and shielding the audio data in the video streaming data previewed and played by other floating layer playing controls.

4. The method according to claim 1, further comprising:
when a click operation direct at the floating layer playing control is monitored, stopping previewing and playing through the floating layer playing control, and jumping to a play page, so as to play the video streaming data previewed and played by the floating layer playing control.

5. The method according to claim 4, further comprising:
when an instruction for closing the play page is monitored, re-acquiring the multimedia streaming data corresponding to the previewing and playing area, and loading the floating layer playing control in the previewing and playing area again, so as to preview and play the multimedia streaming data.

6. The method according to claim 1, further comprising: when a slide operation direct at the current interface is monitored, controlling the thumbnail display area in the current interface to slide, and controlling the floating layer playing control not to slide.

7. The method according to claim 1, further comprising: when a dragging operation direct at the floating layer playing control is monitored, moving the floating layer playing control according to the dragging operation.

8. The method according to claim 7, wherein the method, after moving the floating layer playing control according to the dragging operation, further comprises:
recording a display position corresponding to the moved floating layer playing control, so that the terminal determines a corresponding previewing and playing area according to the display position when receiving an instruction for previewing and playing again.

9. A device for previewing and displaying multimedia streaming data, comprising:
a determination module configured to determine a previewing and playing area corresponding to a thumbnail display area;
an acquisition module configured to acquire multimedia streaming data corresponding to the previewing and playing area;
a loading module configured to load a floating layer playing control in the previewing and playing area; and
a previewing and playing module configured to preview and play the multimedia streaming data through the floating layer playing control.

10. The device according to claim 9, wherein the multimedia streaming data comprises video streaming data, wherein the video streaming data comprises video data and audio data; and
the thumbnail display area is configured to display a video thumbnail.

11. The device according to claim 10, wherein in current interface, when a plurality of the thumbnail display areas are present, and when the number of the previewing and playing area in the current interface is more than one, the previewing and playing module is specifically configured to select the audio data and the video data in any video streaming data, preview and play the audio data and the video data in the corresponding floating layer playing control, and shield the audio data in the video streaming data previewed and played by other floating layer playing controls.

12. The device according to claim 9, further comprising: a monitoring and processing module configured to, when a click operation direct at the floating layer playing control is monitored, stop previewing and playing through the floating layer playing control, and jump to a play page, so as to play the video streaming data previewed and played by the floating layer playing control.

13. A device for previewing and displaying multimedia streaming data, comprising:
a processor; and
an memory for storing commands executed by the processor;
wherein the processor is configured to:
determine a previewing and playing area corresponding to a thumbnail display area;
acquire multimedia streaming data corresponding to the previewing and playing area;
load a floating layer playing control in the previewing and playing area; and
preview and play the multimedia streaming data through the floating layer playing control.

14. The device according to claim 13, wherein the multimedia streaming data comprises video streaming data, wherein the video streaming data comprises video data and audio data; and
the thumbnail display area is configured to display a video thumbnail.

15. The device according to claim 14, wherein in current interface, when a plurality of the thumbnail display areas are present, and when the number of the previewing and playing area in the current interface is more than one, the processor is specifically configured to:
select the audio data and the video data in any video streaming data, preview and play the audio data and the video data in the corresponding floating layer playing control, and shield the audio data in the video streaming data previewed and played by other floating layer playing controls.

16. The device according to claim 13, wherein the processor is further configured to:
when a click operation direct at the floating layer playing control is monitored, stop previewing and playing through the floating layer playing control, and jump to a play page, so as to play the video streaming data previewed and played by the floating layer playing control.

17. The device according to claim 16, wherein the processor is further configured to:
when an instruction for closing the play page is monitored, re-acquire the multimedia streaming data corresponding to the previewing and playing area, and load the floating layer playing control in the previewing and playing area again, so as to preview and play the multimedia streaming data.

18. The device according to claim 13, wherein the processor is further configured to:
when a slide operation direct at the current interface is monitored, control the thumbnail display area in the current interface to slide, and control the floating layer playing control not to slide.

19. The device according to claim 13, wherein the processor is further configured to:
when a dragging operation direct at the floating layer playing control is monitored, move the floating layer playing control according to the dragging operation.

20. The device according to claim 19, wherein the processor is further configured to:
record a display position corresponding to the moved floating layer playing control, so that the device determines a corresponding previewing and playing area according to the display position when receiving an instruction for previewing and playing again.
